(19) United States
(12) Patent Application Publication
(10) Pub. No.: US 2015/0149345 A1
(43) Pub. Date: May 28, 2015

(54) SYSTEM FOR MANAGEMENT OF CUSTOMER SELF-SERVICE TERMINALS

(71) Applicant: NCR Corporation, Duluth, GA (US)

(72) Inventors: Jeff Nayler, Kent (GB); Richard Palmer, London (GB); Michael Camacho, London (GB)

(73) Assignee: NCR Corporation, Duluth, GA (US)

(21) Appl. No.: 14/090,503

(22) Filed: Nov. 26, 2013

(51) Int. Cl. G06Q 20/18

(52) U.S. Cl. CPC G06Q 20/18
USPC 705/39

(57) ABSTRACT

A system for managing customer self-service terminals that includes a plurality of customer self-service terminals, and one or more mobile management devices each containing at least one processor, and configured to communicate with each of the plurality of customer self-service terminals and display an indication that assistance is needed at a particular customer terminal of the plurality of customer self-service terminals.

### FIELD OF THE INVENTION

The present invention relates to a system for managing customer self-service terminals.

### BACKGROUND OF THE INVENTION

There is an increasing need to further utilize automated customer self-service terminals for transactions in environments such as retail banking, ticket purchasing, airline and baggage check-in, etc. However, even with the increased utilization of automated customer self-service terminals in these environments, there is still often a need for human interaction, such as assistance (“help”), or approval in certain transactions. These can include a request for general assistance in navigating through a particular transaction, a request for secondary approval, or for other further verifications of the actions being taken by the customer at the automated customer self-service terminal.

### SUMMARY OF THE INVENTION

Thus, in one form, the present disclosure provides for a system that includes a plurality of customer self-service terminals linked to a server, and one or more mobile management devices communicating with each of the plurality of customer self-service terminals via the server. Each of the plurality of customer self-service terminals are preferably of the type in which a customer is permitted to conduct one or more transactions, such as, for example, an automated teller machine, a ticket vending machine, an airline check-in terminal, retail store self-service check-out terminal, and the like.

The mobile management devices are preferably tablet devices that each contain at least one processor and are configured to receive data from the plurality of customer self-service terminals via the server, and display an indication that assistance is needed at a particular customer terminal of the plurality of customer self-service terminals. In a preferred embodiment, the indication that assistance is needed is represented by displaying a request for assistance manually sent by the customer, an automated request for assistance sent by the customer self-service terminal, a length of time that the customer has been conducting a transaction, and/or a working status of each of the plurality of customer self-service terminals, such as, for example, whether the terminal is unavailable, on-line, in-use, in-use and awaiting assistance, and in-use and assistance is being provided. As used here, the term “assistance” also includes approval, authentication and other forms of human interaction.

### BRIEF DESCRIPTION OF THE DRAWINGS

In order to appreciate the advantages and objects of the invention, a more particular description of the invention will be rendered by reference to specific embodiments thereof which are illustrated in the appended drawings. Understanding that these drawings only depict preferred embodiments of the present invention and are not therefore to be considered limiting in scope, the invention will be described and explained with additional specificity and detail through the use of the accompanying drawings in which:

FIG. 1 is a schematic diagram of a system according to a preferred embodiment of the present invention;

FIG. 2 shows an exemplary display of the mobile management device having a graphical indication of each of the plurality of customer self-service terminals and of the one or more predetermined parameters associated with each of the terminals;

FIG. 3 shows an exemplary detailed display on the mobile management device of a selected customer self-service terminal;

FIG. 4A shows a possible layout of an input for secondary ID verification; and

FIG. 4B shows a possible layout for transaction approval input.

### DETAILED DESCRIPTION OF THE PREFERRED EMBODIMENTS

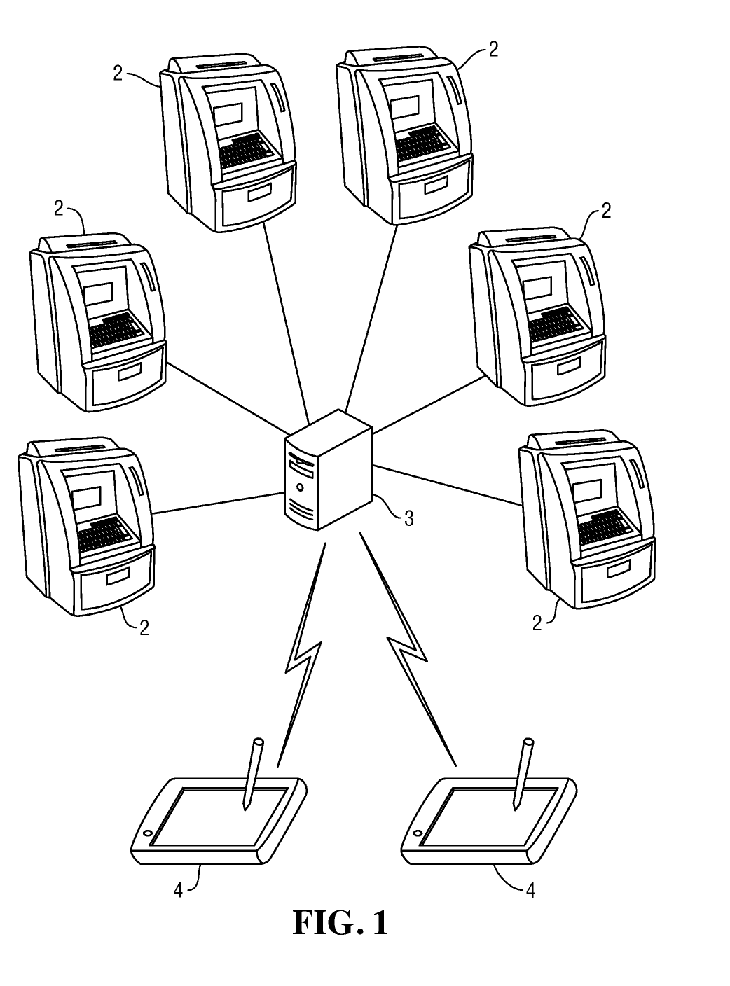

Referring now to the drawings in which like elements are identified with identical reference numerals throughout, FIG. 1 shows a diagram of a system 1 for managing customer self-service terminals. The system 1 includes a plurality of customer self-service terminals 2 linked to a server 3, and one or more mobile management devices 4 communicating with each of the plurality of customer self-service terminals 2 via the server 3. The communication between the mobile management devices 4 and the plurality of self-service terminals 2 can be a direct communication via a PAN such as, for example, a Bluetooth® connection. Each of the plurality of customer self-service terminals 2 is preferably of the type in which a customer is permitted to conduct one or more transactions, such as, for example, an automated teller machine, a ticket vending machine, an airline check-in terminal, retail store self-service check-out terminal, and the like. The mobile management devices 4 are preferably tablet devices that each contain at least one processor and are configured to receive data from the plurality of customer self-service terminals 2 via the server 3.

The following description makes specific reference to the present invention as implemented in a banking environment wherein the plurality of customer self-service terminals 2 are automated teller machines. It will be readily apparent to one of skill in the art that the present invention is not limited to this implementation and can be easily modified for use in conjunction with a ticket vending machine, an airline check-in terminal, retail store self-service check-out terminal, and the like.

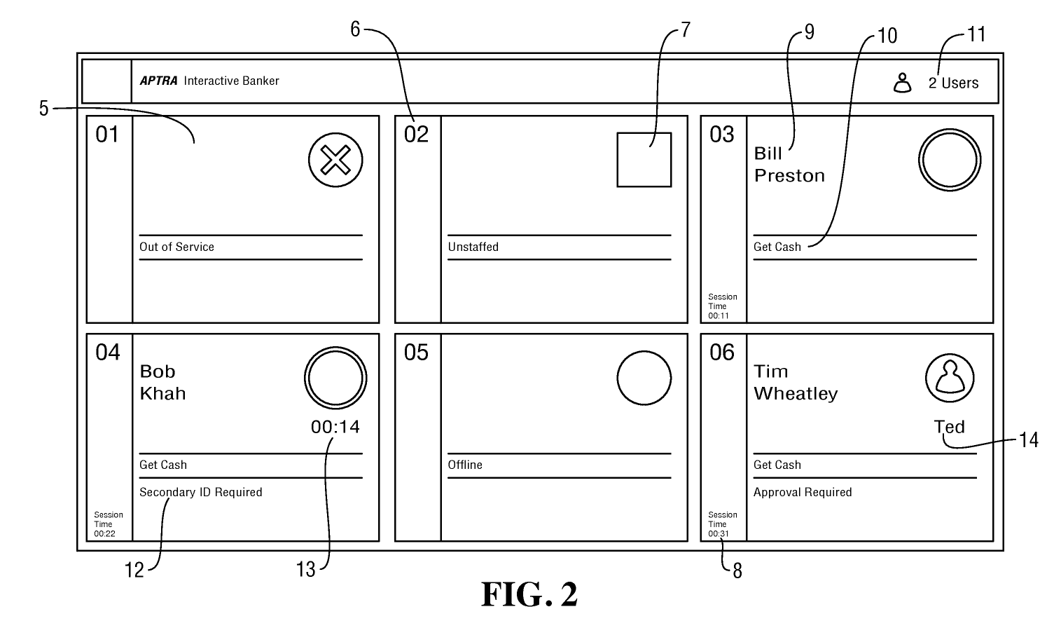

Referring now to FIG. 2, the mobile management devices 4 create and display thereon a graphical indication 5 of each of the plurality of customer self-service terminals 2 and an indication that assistance may be needed at each of the terminals 2. In the depicted banking environment having automated teller machines, the plurality of customer self-service terminals 2 are each preferably displayed with a terminal number 6, a working status indicator 7, the length of time that the customer has been conducting the transaction or transactions at any particular terminal 8, the customer name 9, an indication of the type of transaction being conducted 10, the number of staff members available for assistance 11, an indication of whether a form of secondary approval is required 12 for any given transaction, an indication of how long the customer has been awaiting assistance 13, and the name of the staff members currently assisting customers at a terminal 14. The working status of each particular one of the plurality of customer self-service terminals can be an icon indicating whether the terminal is “unavailable,” “off-line,” “on-line,” “in use,” “in use and awaiting assistance,” “in use and assistance being provided,” or the like.

The plurality of customer self-service terminals 2 preferably also permit the customer to request assistance from the staff members through a selectable icon on the input screen or via a separate button on the terminal itself. In addition, the plurality of customer self-service terminals are further configured to transmit an automatic request for assistance to the mobile management devices when the transaction requires secondary approval or validation for transaction completion or continuation, such as an identity check of the customer or a verification of documentation relating to the transaction. In response to either a customer or automatic request, a request for assistance is sent from the terminal to the mobile management devices via the server or directly to the mobile management device via appropriate communication protocols such as Bluetooth®.

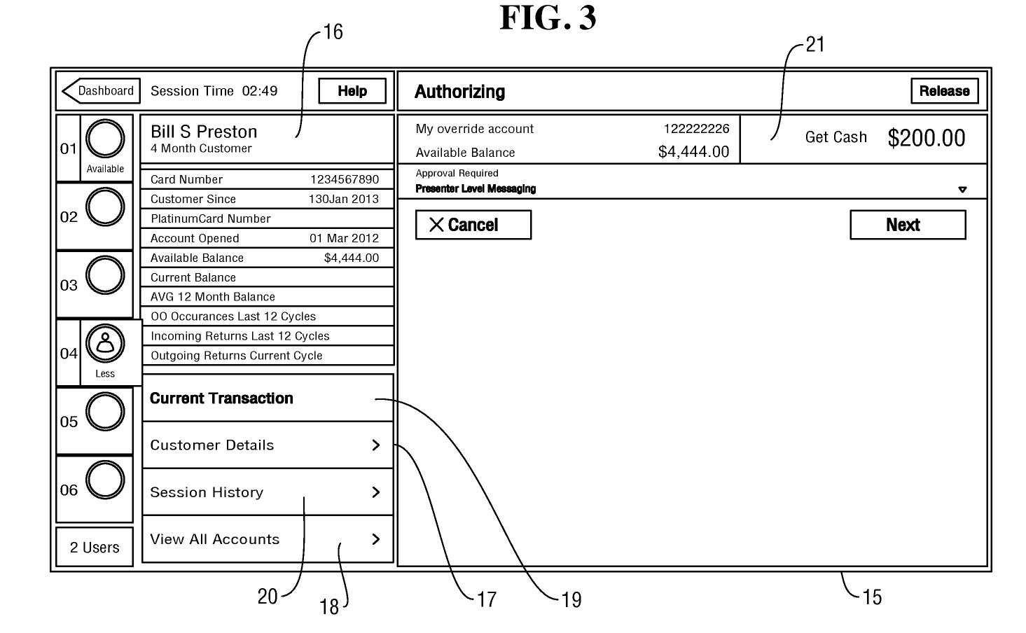

Referring now to FIG. 3, the mobile management devices 4 are configured to generate a detailed display 15 of a customer self-service terminal 2 when the graphical representation 5 of that customer self-service terminal 2 is selected. The detailed display 15 preferably includes customer summary information 16, and selectable icons for further displaying detailed customer information 17, customer accounts 18, current transaction information 19 and session history information 20. In FIG. 3, the “current transaction” icon 19 is selected and shows the details of the current transaction on the right side panel 21 of the display 15 shown in FIG. 3. Providing this detailed display 15 allows the staff member assisting the customer to have customer information readily available so as to better assist the customer in their particular transaction, or to suggest additional services to the customer during the provided assistance. For example, in the banking environment, by reviewing the detailed information about the customer, the staff member may be able to offer financial planning, mortgage services, suggest account upgrades to the customer, or authorize a transaction based on the information about the customer.

When assisting a customer, the mobile management device 4 of the responding staff member can be configured to remotely control one or more functions of the terminal 2 where assistance is being provided by attaching to a customer's transaction session and remotely controlling the interaction with the terminal 2. Technologies for carrying out a remote interaction are well known and vary according to the operating system employed in the devices that are to communicate with each other. Typically, however, remote software consists of two components: a server component installed on the host device to be connected to, and a client component on another device used to connect to the host device via an associated server.

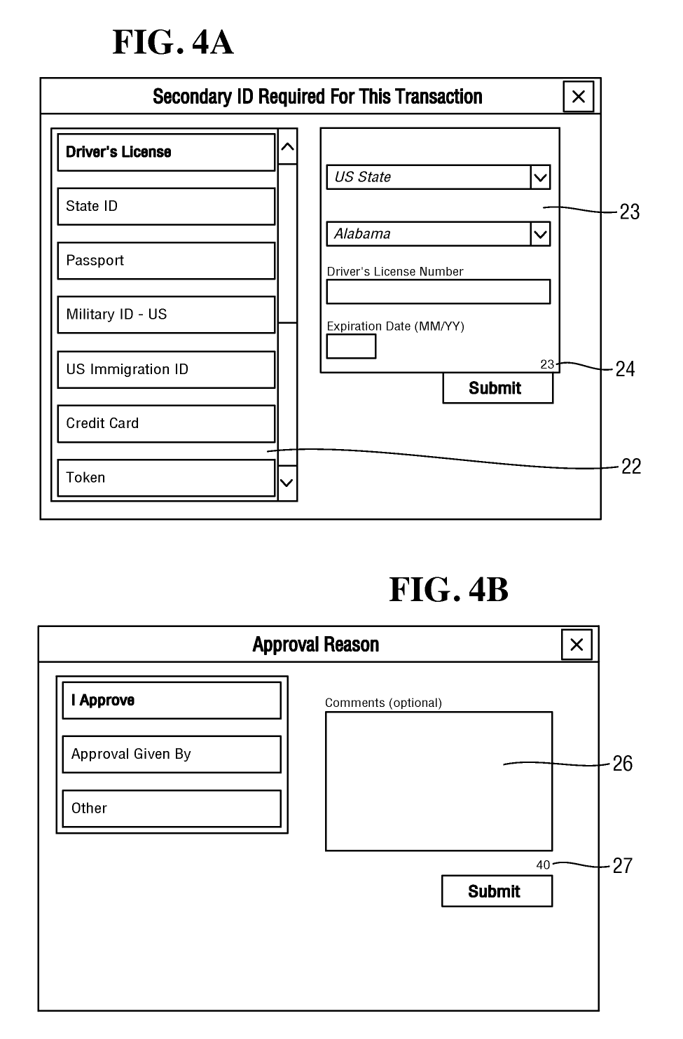

Alternatively, and preferably with a secondary approval or validation, the transaction at the customer self-service terminal 2 is interrupted pending an input from the mobile management device 4 of the responding staff member. FIG. 4A shows a possible layout of the input for a secondary ID verification, and provides a selection of the type of secondary ID being provided 22, along with form fields for the particular type of ID selected 23, and preferably, an indication of the available number of characters for entry 24. FIG. 4B shows a possible layout for a transaction approval, and provides a field for the type of approval that can be given 25, a text field for entry of the reason for the approval 26, and an indication of the number of remaining characters for the approval reason 27. It should be noted that the layouts shown in FIGS. 4A and 4B are merely illustrative, and as such, many other layouts can be used depending on the nature of the transaction being conducted. This secondary approval or validation allows for human interaction when an identity check of the customer or a verification of documentation relating to the transaction is required. When the appropriate approvals are provided, a reply is sent from the mobile management device to the customer terminal and the customer transaction is completed or allowed to continue to the next step in the transaction process.

With such a system, transactions that can be significantly completed without the need for a staff member's assistance, such as a teller at a bank, proceed until the point that staff assistance is required or requested in the transaction. This allows the greater utilization of automated self-service terminals without the need for a large number of personnel, while at the same time providing appropriate customer assistance when needed or requested. In addition, for transactions that require secondary approval, the above-described system provides the level of risk management and regulatory compliance needed for such transactions.

While the foregoing description and drawings represent an illustrative embodiment of the present invention, it will be understood that various additions, modifications, and substitutions may be made therein without departing from the spirit and scope of the present invention as defined in the accompanying claims. Therefore, the present invention is not limited to only the embodiments specifically described herein. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. A system for managing customer self-service terminals, the system comprising:
a plurality of customer self-service terminals;
one or more mobile management devices each containing at least one processor, and configured to communicate with each of the plurality of customer self-service terminals and display an indication that assistance is needed at a particular customer terminal of the plurality of customer self-service terminals.

2. The system for managing customer self-service terminals according to claim 1, wherein the indication is a working status of each of the plurality of customer self-service terminals.

3. The system for managing customer self-service terminals according to claim 2, wherein the working status is one of terminal unavailable, terminal on-line, terminal in-use, terminal in-use and awaiting assistance, and terminal in-use and assistance being provided.

4. The system for managing customer self-service terminals according to claim 1, wherein the indication is a length of time that the customer has been conducting the at least one transaction.

5. The system for managing customer self-service terminals according to claim 1, wherein the one or more mobile management devices are further configured to generate a graphical representation of each of the plurality of customer self-service terminals.

6. The system for managing customer self-service terminals according to claim 5, wherein the one or more mobile management devices are further configured to generate a detailed display of a customer self-service terminal when the graphical representation of that customer self-service terminal is selected.

7. The system for managing customer self-service terminals according to claim 6, wherein the detailed display includes at least one of customer information, customer accounts, current transaction information and session history information.

8. The system for managing customer self-service terminals according to claim 1, wherein the one or more mobile management devices are further configured to display staff members available for assistance, staff members currently assisting customers, and an indication of the customer self-service terminal at which assistance is being provided.

9. The system for managing customer self-service terminals according to claim 1, wherein the plurality of customer self-service terminals are further configured to permit the customer to request assistance, and to transmit a request for assistance to the one or more mobile management devices.

10. The system for managing customer self-service terminals according to claim 1, wherein the plurality of customer self-service terminals are further configured to transmit an automatic request for assistance to the one or more mobile management devices when a transaction requires secondary approval or validation for transaction completion or continuation.

11. A mobile management device for managing customer self-service terminals, the mobile management device comprising:
at least one processor containing a program that causes the mobile management device to communicate with a plurality of customer self-service terminals and display an indication that assistance is needed at a particular customer terminal of the plurality of customer self-service terminals on a display of the mobile management device.

12. The mobile management device for managing customer self-service terminals according to claim 11, wherein the indication is a working status of the plurality of customer self-service terminals.

13. The mobile management device for managing customer self-service terminals according to claim 12, wherein the working status is one of terminal unavailable, terminal on-line, terminal in-use, terminal in-use and awaiting assistance, and terminal in-use and assistance being provided.

14. The mobile management device for managing customer self-service terminals according to claim 11, wherein the indication is a length of time that the customer has been conducting the at least one transaction.

15. The mobile management device for managing customer self-service terminals according to claim 11, wherein the mobile management device is further configured to generate a graphical representation of each of the plurality of customer self-service terminals.

16. The mobile management device for managing customer self-service terminals according to claim 15, wherein the mobile management device is further configured to generate a detailed display of a customer self-service terminal when the graphical representation of that customer self-service terminal is selected.

17. The mobile management device for managing customer self-service terminals according to claim 16, wherein the detailed display includes at least one of customer information, customer accounts, current transaction information and session history information.

18. The mobile management device for managing customer self-service terminals according to claim 11, wherein the mobile management device is further configured to display staff members available for assistance, staff members currently assisting customers, and an indication of the customer self-service terminal at which assistance is being provided.

19. A method of managing customer self-service terminals, the method comprising:
receiving data from a plurality of customer self-service terminals; and
displaying an indication that assistance is needed at a particular customer terminal of the plurality of customer self-service terminals on a display of a mobile management device.

20. The method of managing customer self-service terminals according to claim 19, wherein the indication is a working status of the plurality of customer self-service terminals.

21. The method of managing customer self-service terminals according to claim 20, wherein the working status is one of terminal unavailable, terminal on-line, terminal in-use, terminal in-use and awaiting assistance, and terminal in-use and assistance being provided.

22. The method of managing customer self-service terminals according to claim 19, wherein the indication is a length of time that the customer has been conducting the at least one transaction.
